(19) United States
(12) Patent Application Publication
(10) Pub. No.: US 2025/0310373 A1
(43) Pub. Date: Oct. 2, 2025

(54) MASKED COMPRESSION

(71) Applicant: STMicroelectronics International N.V., Geneva (CH)

(72) Inventors: Guilhem Assael, Rians (FR); Gilles Van Assche, Woluwe-St-Lambert (BE)

(21) Appl. No.: 19/092,606

(22) Filed: Mar. 27, 2025

(30) Foreign Application Priority Data
Mar. 28, 2024 (FR) FR2403181

(51) Int. Cl. H04L 9/40; G06F 7/499

(52) U.S. Cl. CPC H04L 63/1466; G06F 7/49931

(57) ABSTRACT

The present description concerns a method comprising masking, based on a digital algorithm, by a processing device, a sensitive data item, the masking comprising dividing the data item into a number n greater than or equal to 2 of shares, such that their arithmetic sum, modulo an integer q associated with the digital algorithm, is equal to the value of the data item, applying a compression operation to each of the n data shares, comprising applying a rounding operation to each of the n data shares, resulting in n integer rounding values, and applying a pseudo-fractional operation to each of the n data shares, resulting in n pseudo-fractional values, and generating n corrected compressed data shares by applying a correction operation to each of the rounding n values, based on the n pseudo-fractional values.

### CROSS-REFERENCE TO RELATED APPLICATIONS

This application claims the benefit of French Patent Application No. FR2403181, filed on Mar. 28, 2024, which application is hereby incorporated herein by reference.

### TECHNICAL FIELD

The present disclosure generally concerns the field of cryptography and in particular the field of encrypted data compression.

### BACKGROUND

A side-channel attack carried out during a cryptographic operation involving a sensitive data item, such as for example an encryption key, may enable an outside entity to deduce the value of the sensitive data item.

A protection against such attacks consists in masking the sensitive data by dividing them into a plurality of “shares”. However, in certain cases, it is also desirable to compress the sensitive data, for example during encapsulation or decapsulation operations. However, masking operations are not compatible with compression operations, and the combination of masking and compression operations is not efficient since it does not enable to obtain a result without performing a high number of operations.

There exists a need to make masking and compression operations compatible.

### SUMMARY

An embodiment provides a method comprising masking, based on a digital algorithm, by a processing device, a sensitive data item, the masking comprising dividing the sensitive data item into a number n of shares, n being an integer equal to or greater than 2, such that their arithmetic sum, modulo an integer q associated with the digital algorithm, is equal to the value of the sensitive data item, applying a first operation of compression of each of the n data shares, the first compression operation comprising applying a rounding operation to each of the n data shares, resulting in n integer rounding values, and applying a pseudo-fractional operation, to each of the n data shares, resulting in n pseudo-fractional values, and generating n corrected compressed data shares by applying a correction operation to each of the n rounding values, based on the n pseudo-fractional values.

According to an embodiment, the arithmetic sum, modulo an integer p associated with the digital algorithm, between the n shares corresponds to the compressed sensitive data item, based on a second compression operation, associated with the digital algorithm, the second compression operation being based on a calculation of a rounding or truncation value of the form compress_{q,p,r} where value q is an integer associated with the digital algorithm, value p is an integer corresponding to a range of the form {0, 1, . . . , p−1} expected for the result of the second compression operation, and integer value r is a term defining the compression operation, integer r being, for example, equal to 0 when the second compression operation associated with the digital algorithm is a truncation operation, or equal to

$$⌊ \frac{q}{2} ⌋$$

when the second compression operation associated with the digital algorithm is a rounding operation.

According to an embodiment, the rounding operation, on a share xᵢ of the sensitive data item, corresponds to the calculation of integer

$${int}_{i} = ⌊ \frac{{x}_{i} p + {r}_{i}}{q} ⌋ mod p ,$$

where rᵢ is a truncation term associated with share xᵢ and └⋅┘ is the truncation operation towards the equal or immediately lower integer, and the pseudo-fractional operation on share xᵢ corresponds to the calculation of value fᵢ=(xᵢp+rᵢ)mod q.

According to an embodiment, the sum of the n truncation terms is equal to integer r.

According to an embodiment, the n truncation terms are generated by a random number generator of the first device.

According to an embodiment, the correction operation comprises determining an integer c such that c is equal to value j, j∈{0, . . . n−1} when the sum of the pseudo-fractional values f₀+ . . . +fₙ₋₁ belongs to interval [jq,(j+1)q], generating a correction vector, of size n, such that the arithmetic sum modulo p of the n components of the correction vector is equal to integer c, and, for each index i∈{1, n}, adding the i-th component of the correction vector to the rounding value intᵢ of the i-th share.

According to an embodiment, the processing device is configured to control the deleting of the n pseudo-fractional values as a consequence of the calculation of the correction vector.

According to an embodiment, the digital algorithm is a cryptographic scheme and the processing device is a cryptographic processor or a cryptographic coprocessor.

According to an embodiment, the cryptographic scheme is a lattice-based encapsulation scheme.

According to an embodiment, the lattice is a lattice of ML-KEM type, a lattice of ML-DSA type, a Kyber-type lattice, or a NewHope-type lattice.

According to an embodiment, number n is equal to 2.

According to an embodiment, the above method further comprises the processing, by the processing device, of the n corrected compressed data shares, the processing for example forming part of a decapsulation operation.

Another embodiment provides a device comprising a processing device configured to apply a masking, based on a digital algorithm, to a sensitive data item, the masking comprising the division of the sensitive data item into a number n of shares, n being an integer equal to or greater than 2, such that their arithmetic sum, modulo an integer q associated with the digital algorithm, is equal to the value of the sensitive data item, apply a compression operation to each of the n data shares, the compression operation comprising applying a rounding operation to each of the n data shares, resulting in n integer rounding values, and applying a pseudo-fractional operation, to each of the n data shares, resulting in n pseudo-fractional values, and generate n corrected compressed data shares by applying a correction operation to each of the n rounding values, based on the n pseudo-fractional values.

According to an embodiment, the processing device is configured to apply the correction operation by determining an integer c such that c is equal to value j, j∈{0, . . . n−1} when the sum of the pseudo-fractional values f₀+ . . . +fₙ₋₁ belongs to interval [jq,(j+1)q], generating a correction vector, of size n, such that the arithmetic sum modulo p of the n components of the correction vector is equal to integer c, and, for each index i∈{1, n}, adding the i-th component of the correction vector to the rounding value intᵢ of the i-th share.

According to an embodiment, the processing device is configured to control the deleting of the n pseudo-fractional values as a consequence of the calculation of the correction vector.

According to an embodiment, the processing device is further configured to process the n corrected compressed data shares, for example in a decapsulation operation.

According to an embodiment, the digital algorithm is a cryptographic scheme and the processing device is a cryptographic processor or a cryptographic coprocessor.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 schematically shows an example of an electronic device of the type to which the described embodiments apply;

FIG. 2 is a block diagram illustrating an operation of compression of a masked data item, according to an embodiment of the present disclosure; and

FIG. 3 is a flowchart illustrating steps of a masked data compression method, according to an embodiment of the present disclosure.

### DETAILED DESCRIPTION OF ILLUSTRATIVE EMBODIMENTS

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail. In particular, the lattice-based cryptographic operations are not described in detail and are known to those skilled in the art. Similarly, the encapsulation and decapsulation operations are not described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10% or 10°, preferably of plus or minus 5% or 5°.

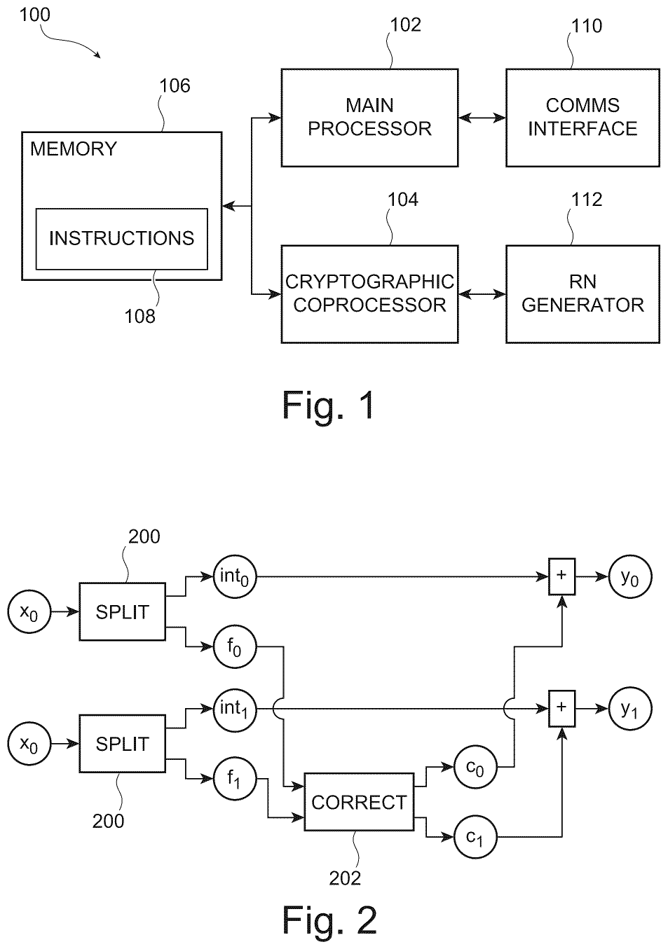

FIG. 1 schematically illustrates a device 100 according to an embodiment. Device 100 is, for example, a computer, a cell phone, or a smart card.

Device 100 comprises, for example, a main processor 102, which is for example a host processor of device 100, and a cryptographic coprocessor 104. Device 100 further comprises a memory 106 storing instructions 108 for controlling main processor 102 and cryptographic coprocessor 104. A communication interface 110 is, for example, coupled to main processor 102, and enables, for example, wireless communications via a wireless communications network, and/or wired communications, for example via a LAN (Local Area Network, not illustrated).

Device 100, and in particular cryptographic coprocessor 104, is for example adapted to performing cryptographic operations. As an example, device 100 further comprises a random number (RN) generator 112 connected to cryptographic coprocessor 104. In another example, cryptographic coprocessor 104 is itself configured to perform random number generation operations.

Cryptographic coprocessor 104 is for example configured to perform encapsulation operations, for example based on a random key generated by number generator 112. As an example, the encapsulation operations executed by cryptographic coprocessor 104 are carried out based on a public encryption key, for example stored in memory 106. In other examples, the public encryption key is securely stored in cryptographic coprocessor 104.

Cryptographic coprocessor 104 is for example configured to encrypt data based on a cryptographic encryption algorithm, here called “cryptographic scheme”. As an example, a cryptographic scheme is, further, a cryptographic algorithm distributed between a plurality of devices, for example configured to perform encapsulation and decapsulation operations based on an asymmetric pair of keys. As an example, the cryptographic scheme is a lattice-based scheme, such as:
an ML-KEM scheme, for “Module-Lattice-Based Key-Encapsulation Mechanism”, described in publication: NIST, Module-Lattice-Based Key-Encapsulation Mechanism Standard, FIPS 203 (Initial Public Draft), August 2023, doi:10.6028/NIST.FIPS.203.ipd;
an ML-DSA scheme: NIST, Module-Lattice-Based Digital Signature Standard, FIPS 204 (Initial Public Draft), August 2023, doi:10.6028/NIST.FIPS.204.ipd;
a Kyber scheme: Roberto Avanzi, Joppe Bos, Léo Ducas, Eike Kiltz, Tancrède Lepoint, Vadim Lyubashevsky, John M. Schanck, Peter Schwabe, Gregor Seiler, and Damien Stehlé, CRYSTALS-Kyber Algorithm Specifications And Supporting Documentation (version 3.02), 2021, https://pq-crystals.org/kyber/data/kyber-specification-round3-20210804.pdf; or
a NewHope scheme: Erdem Alkim, Roberto Avanzi, Joppe Bos, Léo Ducas, Antonio de la Piedra, Thomas Pöppelmann, Peter Schwabe, Douglas Stebila, Martin R. Albrecht, Emmanuela Orsini, Valery Osheter, Kenneth G. Paterson, Guy Peer, Nigel P. Smart, NewHope Algorithm Specifications and Supporting Documentation (version 1.1), 2020, https://newhopecrypto.org/data/NewHope_2020_04_10.pdf.

Generally, the cryptographic scheme includes an operation of compression of integral type data.

Cryptographic coprocessor 104 is further configured to perform masking operations. As an example, the masking operation occurs before device 100 transmits, for example via interface 110, a native data item, for example the encrypted random key, to another device. The native data item is, for example, a sensitive data item, and it is not desirable for its value to be known by other devices than device 100. In particular, it is important to ensure a protection against side-channel attacks for the so-called sensitive data manipulated by cryptographic coprocessor 104. The operation of masking of a native data item corresponds to its division into a number of n of shares, n being an integer. As an example, n is equal to 2. In another example, number n is at least equal to 3. In particular, the n data shares are randomly generated, so that their sum is equal to the native data item. In particular, each value of a data share is independent of the value of the native data item. Thus, the observations of n−1 data shares, for example during a side-channel attack, reveal no information as to the value of the native data item.

A Boolean-type masking uses the exclusive-OR operation, denoted ⊕, to divide a value x into n random values x₀, . . . , xₙ₋₁ such that x=x₀⊕ . . . ⊕xₙ₋₁. An arithmetic-type masking uses an addition operation modulo an arbitrary number q. The value of data item x and of shares x₀, . . . , xₙ₋₁ are such that x=(x₀+ . . . +xₙ₋₁)mod q. The type of masking performed is for example selected as a function of the calculations to be performed on a native data item, in accordance with the implemented cryptographic scheme. The masking operations are stable by linear transformation, the linearity being understood according to the addition operation selected in the masking. In other words, a masking of data item x to which a linear transformation is applied, corresponds to the application of this same linear transformation to each share xᵢ, i∈{0, . . . , n−1}. However, masking operations are not stable by non-linear transformation. The different types of masking, as well as their implementations, are known to those skilled in the art.

Cryptographic coprocessor 104 is further configured to perform compression operations, for example, on encrypted data. Compression operations are, for example, performed to decrease the size of the data item before, for example, transmitting it to another device.

However, usual compression operations correspond to the calculation of a rounding value. Rounding operations are non-linear operations and are accordingly not compatible with masking operations. In particular, for a compression operation compress defined as being the calculation of a rounding or truncation value based on a data value, the compressed value compress(x) is not equal to the sum of the compressed values compress(xᵢ) of each share. Thus, when a device receives, from device 100, the compressed values compress(xᵢ), i∈{0, . . . , n−1}, it cannot reconstruct the compressed value x. As an example, a compression operation compress_{q,p,r} is such that, for a data value x,

$${compress}_{q , p , r} ( x ) = ⌊ \frac{x p + r}{q} ⌋ mod p ,$$

where operation └⋅┘ is the truncation to the equal or immediately lower integer value. Value q is an integer associated with the cryptographic scheme used. As an example, the value of number q is selected upstream, for example by the manufacturer of cryptographic coprocessor 104 or, more generally, of device 100. Value p is an integer corresponding to the range, in the form {0, 1, . . . , p−1}, expected for the result of the compression operation performed. As an example, the value of integer p is selected beforehand, for example by the manufacturer of cryptographic coprocessor 104 or, more generally, of device 100. Integer value r is a term defining the compression operation. In particular, if r is equal to 0, then the compression operation corresponds to a truncation, and if r is equal to

$$⌊ \frac{q}{2} ⌋ ,$$

the compression operation corresponds to a rounding. According to an embodiment, cryptographic coprocessor 104 is configured to perform compression operations, for example by executing instructions 108, compatible with the masking operations. Thus, the sum of the values compressed, by cryptographic coprocessor 104, of each share xᵢ, i∈{0, . . . , n−1}, corresponds to the compressed value of data item x.

FIG. 2 is a block diagram illustrating an operation of compression of a masked data item, according to an embodiment of the present disclosure.

The compression operation is for example implemented in software fashion. As an example, instructions 108 are configured to be executed by cryptographic coprocessor 104 in order to generate, based on n shares xᵢ, i∈{0, . . . , n−1} of a data x, a number n of compressed and corrected shares yᵢ. In the example illustrated in FIG. 2, the number n of shares is equal to 2.

As an example, shares xᵢ, i∈{0, . . . , n−1} are generated by cryptographic coprocessor 104 as a result of a masking operation, for example by using arithmetic masking on data item x.

According to an embodiment, for each of shares xᵢ, i∈{0, . . . , n−1}, a rounding value intᵢ as well as a pseudo-fractional value fᵢ are calculated by cryptographic coprocessor 104. The rounding values and the pseudo-fractional values are for example calculated by application of a split function 200.

According to an embodiment xᵢ, i∈{0, . . . , n−1}, the split function applied is a function split_{p,q}^{r}^{ᵢ}, such that split_{p,q}^{r}^{ᵢ}(xᵢ)=(intᵢ, fᵢ), where

$$i n {t}_{i} = ⌊ \frac{{x}_{i} p + {r}_{i}}{q} ⌋ mod p ,$$

$$and$$

$${f}_{i} = ( {x}_{i} p + {r}_{i} ) mod q ,$$

and where operation └⋅┘ is the truncation to the equal or immediately lower integer value. Value q is the integer associated with the cryptographic scheme used, and corresponds in particular to the value used for the arithmetic masking of shares xᵢ. In particular, value q is the same as that defined in relation with the compress_{q,p,r} operation. Similarly, value p is the same as that defined in relation with the compress_{q,p,r} operation. Integer value rᵢ is a truncation term, associated with share xᵢ. The n truncation terms r₀, . . . , rₙ₋₁ are such that their sum r₀+ . . . +rₙ₋₁ modulo pq is equal to value r, defined in relation with the compress_{q,p,r} operation. As an example, in the case where n=2 and where

$$r = ⌊ \frac{q}{2} ⌋ ,$$

terms r₀ and r₁ are such that r₀=0 and

$${r}_{1} = ⌊ \frac{q}{2} ⌋ ,$$

in another example,

$$⌊ \frac{q}{2} ⌋$$

is an even value and terms r₀ and r₁ are such that

$${r}_{0} = ⌊ \frac{q}{4} ⌋ = {r}_{1} ,$$

etc. In the general case, where integer n is greater than or equal to 2, one of the truncation terms is, for example, equal to

$$⌊ \frac{q}{2} ⌋$$

and all the others are zero, in another example,

$$⌊ \frac{q}{2} ⌋$$

is a value divisible by n and all terms are equal to

$$⌊ \frac{q}{2 n} ⌋ ,$$

etc. Generally, any values are possible for the terms rᵢ, i∈{0, . . . , n−1} as long as their sum is equal to value r. In particular, when value r is equal to o, terms rᵢ are, for example, all zero. In another example, their sum modulo pq is equal to 0.

In other examples, the terms rᵢ, i∈{0, . . . , n−1} are randomly generated, for example by random number generator 112. As an example, the terms are generated on the fly, as a result of each command of execution of instructions 108. Thus, for two different data items, x and x, the truncation terms associated with shares x₀, . . . , xₙ₋₁ and \tilde{x}₀, . . . , \tilde{x}ₙ₋₁ vary. This random generation of the truncation terms offers an additional protection against side-channel attacks.

The pseudo-fractional values fᵢ, i∈{0, . . . , n−1} each belong to the set {0, . . . , (n−1)q}.

According to an embodiment, cryptographic coprocessor 104 is further configured to calculate n correction values cᵢ, i∈{0, . . . , n−1} based on the n pseudo-fractional values fᵢ, i∈{0, . . . , n−1}. As an example, the calculation of the correction values is performed by application of a correction operation 202 to the n pseudo-fractional values.

According to an embodiment, correction values cᵢ, i∈{0, . . . , n−1} are integer values belonging to set {0, . . . , p−1} and are arithmetic shares modulo p of an integer c belonging to the set {0, . . . , n−1}. In other words, c=c₀+c₁+ . . . +cₙ₋₁ mod p=j∈0, . . . , n−1. In particular, integer c is equal to value j, j∈{0, . . . n−1} when the sum of pseudo-fractional values f₀+ . . . +fₙ₋₁ belongs to interval [jq,(j+1)q].

As an example, when n=2, an implementation of the correction function comprises the calculation of a vector g corresponding to the sum of the pseudo-fractional values, minus value q, under an arithmetic masking modulo a number greater than or equal to 2q. As an example, vector g is equal to (f₀−q, f₁). In another example, vector g is equal to (f₀−q/2, f₁−q/2). The calculation of the correction values further comprises the calculation of a sign vector s. For example, vector s is equal to the complement of Boolean vector MSB(A2B(g)), where the MSB operation corresponds to the selection of the most significant bit of each element of the provided vector and where the A2B operation corresponds to the conversion of an arithmetic masking, modulo a number greater than or equal to 2q, into a Boolean masking. The correction values are then obtained by conversion of Boolean vector s into an arithmetic masking modulo p. In other words, a correction vector c=(c₀, . . . , cₙ₋₁), having as components the n correction values, is such that c=B2A(s), where operation B2A is the conversion from Boolean to arithmetic values.

Those skilled in the art will be capable of adapting the implementation of the correction function in the case where n is greater than 2, based on the functional indications of the present disclosure, such as the correction values ca mentioned hereabove.

As an example, once correction vector c has been calculated, cryptographic coprocessor 104 is configured to delete the pseudo-fractional values f₀, . . . , fₙ₋₁ values stored, for example, in a buffer memory of coprocessor 104.

According to an embodiment, cryptographic coprocessor 104 is further configured to calculate, for any i∈{0, . . . , n−1}, a corrected compressed share y; by adding (+) correction value cᵢ to the rounding value intᵢ, the addition being considered modulo p.

The corrected compressed shares yᵢ, i∈{0, . . . , n−1} are then such that their sum modulo p correspond to the compressed data item x, that is, to

$${compress}_{q , p , r} ( x ) = ⌊ \frac{x p + r}{q} ⌋ mod p ,$$

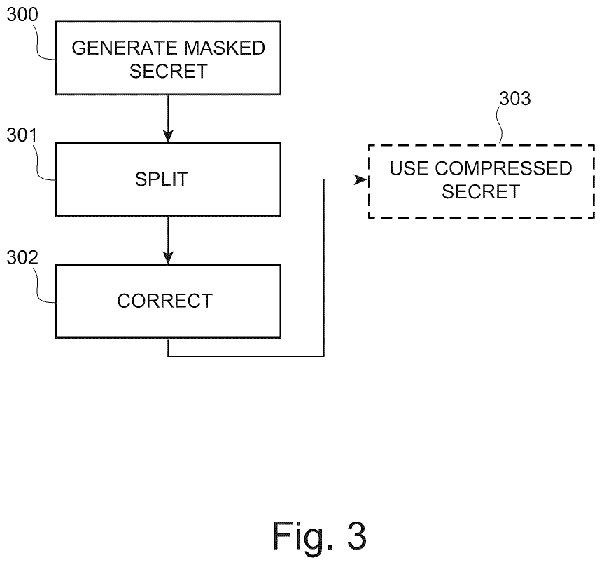

FIG. 3 is a flowchart illustrating steps of a masked data compression method, according to an embodiment of the present disclosure.

In a generate masked secret step 300, a sensitive data item x is, for example, manipulated by cryptographic coprocessor 104. As an example, the sensitive data item is an intermediate variable of a cryptographic scheme. As an example, sensitive data item x is a value following a re-encryption in a data integrity and/or authenticity verification step.

In particular, the sensitive data item is a data item masked according to an arithmetic masking modulo q. Sensitive data item x comprises, for example, a number n of shares (x₀, . . . , xₙ₋₁). In another example, the sensitive data item is a non-masked data item. Cryptographic coprocessor 104 is then configured to apply an arithmetic masking modulo q to this value, by generating, for example via random number generator 112, n−1 random numbers x₀, . . . , xₙ₋₂ between o and q−1. Cryptographic coprocessor 104 is then configured to generate share xₙ₋₁ such that xₙ₋₁=x−x₀−x₁− . . . −xₙ₋₂. Generally, cryptographic coprocessor 104 is configured to generate n shares (x₀, . . . , xₙ₋₁) of data item x such that x₀+ . . . +xₙ₋₁ mod q=x.

In a split step 301, cryptographic coprocessor 104 is configured to apply the split operation 200 to each of shares xᵢ, i∈{0, . . . , n−1}. Rounding values intᵢ and pseudo-fractional values fᵢ, i∈{0, . . . , n−1}, such as described in relation with FIG. 2 are then obtained. As an example, cryptographic coprocessor 104 is further configured to store, for example in a buffer memory, the rounding values and the pseudo-fractional values.

In a correction step 302, cryptographic coprocessor 104 is configured to calculate correction values cᵢ, i∈{0, . . . , n−1} by calculating, for example, correction vector c as described in relation with FIG. 2. As an example, after the calculation of vector c, the pseudo-fractional values are deleted from the memory in which they were stored. Cryptographic coprocessor 104 is further configured to, during the carrying out of step 302, generate the corrected compressed shares yᵢ, i∈{0, . . . , n−1} by adding to each rounding value intᵢ, i∈{0, . . . , n−1} the correction value cᵢ modulo p.

In a use compressed secret step 303, cryptographic coprocessor 104 is configured, for example, to use the corrected compressed data shares yᵢ, i∈{0, . . . , n−1}. As an example, cryptographic coprocessor 104 is configured to use the corrected compressed data shares yᵢ in a sequence of operations comprised in the cryptographic scheme to generate an output data item, for example encrypted. As a variant, when the cryptographic scheme is an ML-KEM or Kyber scheme, cryptographic coprocessor 104 is configured to compare, in a decapsulation step, the corrected compressed data shares with an encrypted data item, for example transmitted by another device, and to generate an output signal indicating the result of this comparison.

It would also be possible to transmit the corrected compressed data to another device, for example after encryption in the case of sensitive data.

In another example, cryptographic coprocessor 104 is configured to add up, modulo p, the corrected compressed data shares to generate and output an unmasked result of the compressed value x. The compressed value x is for example then used in a sequence of operations comprised in the cryptographic scheme to generate an output data item.

An advantage of the described embodiments is that they enable to compress masked data, without altering the value of the native data item. In particular, the described embodiments allow the generation of compressed and corrected data shares having their sum modulo a value p corresponding to the compressed data item. The combination of masking and compression operations has the advantage of providing additional protection against side-channel attacks.

Another advantage of the described embodiments is that the split and correction operations described in relation with FIG. 2 are compatible with different cryptographic schemes.

Various embodiments and variants have been described. Those skilled in the art will understand that certain features of these various embodiments and variants may be combined, and other variants will occur to those skilled in the art. In particular, as to the selection of the truncation terms, any combination of positive or zero values can be envisaged, provided for their sum to be equal to value r, defined in the compress_{q,p,r} compression operation. Similarly, the calculation of the correction vector can take several forms, provided for it to corresponds to an arithmetic masking modulo p of value j when the sum of pseudo-fractional values f₀+ . . . +fₙ₋₁ belongs to interval [jq,(j+1)q].

Finally, the practical implementation of the described embodiments and variants is within the abilities of those skilled in the art based on the functional indications given hereabove. In particular, with regard to the cryptographic scheme used. Further, although encapsulation and decapsulation operations have been described, the split and correction operations described in relation with FIG. 2 apply in any context where it is desirable to protect the value of a data item against side-channel attacks. As an example, these operations also apply in operations of layers of a neural network, for example in subsampling operations. In non-cryptographic applications, such as secure computations on neural networks, it will be possible to replace the cryptographic scheme with another type of digital algorithm, and to omit the cryptographic coprocessor, the masking being carried out, for example, by a processing device, such as main processor 102.

What is claimed is:

1. A method comprising:
masking, based on a digital algorithm, by a processing device, a sensitive data item (x), the masking comprising dividing the sensitive data item into a number n of data shares (x₀, . . . , xₙ₋₁), n being an integer equal to or greater than 2, such that their arithmetic sum, modulo an integer q associated with the digital algorithm, is equal to a value of the sensitive data item;
applying a first compression operation to each of the n data shares, the first compression operation comprising:
applying a rounding operation to each of the n data shares, resulting in n integer rounding values (int₀, . . . , intₙ₋₁); and
applying a pseudo-fractional operation, to each of the n data shares, resulting in n pseudo-fractional values (f₀, . . . , fₙ₋₁); and
generating n corrected compressed data shares (y₀, . . . , yₙ₋₁) by applying a correction operation to each of the n rounding values, based on the n pseudo-fractional values.

2. The method according to claim 1, wherein the arithmetic sum, modulo an integer p associated with the digital algorithm, between the n shares (y₀, . . . , yₙ₋₁) corresponds to the sensitive data item (x), compressed, based on a second compression operation (compress_(q,p,r)), associated with the digital algorithm, the second compression operation being based on a calculation of a rounding or truncation value having a form compress_{q,p,r} where value q is an integer associated with the digital algorithm, value p is an integer corresponding to a range having a form \{0, 1, . . . , p−1} expected for a result of the second compression operation, and integer value r is a term defining the second compression operation, integer r being:
equal to 0 in response to the second compression operation associated with the digital algorithm being a truncation operation; or
equal to
$$⌊ \frac{q}{2} ⌋$$
in response to the second compression operation associated with the digital algorithm being a rounding operation.

3. The method according to claim 2, wherein:
the rounding operation, on a share xᵢ of the sensitive data item, corresponds to a calculation of integer
$${int}_{i} = ⌊ \frac{{x}_{i} p + {r}_{i}}{q} ⌋ mod p ,$$
where rᵢ is a truncation term associated with share xᵢ and └⋅┘ is the truncation operation towards an equal or immediately lower integer; and
the pseudo-fractional operation, on share xᵢ corresponds to a calculation of value fᵢ=(xᵢp+rᵢ)mod q.

4. The method according to claim 3, wherein a sum of n truncation terms (r₀, . . . , rₙ₋₁) is equal to integer r.

5. The method according to claim 4, wherein the n truncation terms (r₀, . . . , rₙ₋₁) are generated by a random number generator of the first device.

6. The method according to claim 2, wherein the correction operation comprises:
determining an integer c such that c is equal to value j, j∈{0, . . . n−1} when a sum of the pseudo-fractional values f₀+ . . . +fₙ₋₁ belongs to interval [jq,(j+1)q];
generating a correction vector (c₀, . . . , cₙ₋₁) of size n, such that an arithmetic sum modulo p of n components of the correction vector is equal to integer c; and
for each index i∈{1, n}, adding an i-th component (cᵢ) of the correction vector to the rounding value intᵢ of an i-th share (xᵢ).

7. The method according to claim 6, wherein the processing device is configured to control a deleting of the n values as a consequence of the generating the correction vector.

8. The method according to claim 1, wherein the digital algorithm is a cryptographic scheme and the processing device is a cryptographic processor or a cryptographic coprocessor.

9. The method according to claim 8, wherein the cryptographic scheme is a lattice-based encapsulation scheme.

10. The method according to claim 9, wherein the lattice is a lattice of ML-KEM type, a lattice of ML-DSA type, a Kyber-type lattice, or a NewHope-type lattice.

11. The method according to claim 1, wherein the number n is equal to 2.

12. The method according to claim 1, further comprising processing, by the processing device, the n corrected compressed data shares (y₀, . . . , yₙ₋₁), as part of a decapsulation operation.

13. A device comprising:
a non-transitory memory comprising instructions; and
a processing device communicatively coupled to the memory, wherein the processing device is configured to execute the instructions to:
apply a masking, based on a digital algorithm, to a sensitive data item (x), the masking comprising a division of the sensitive data item into a number n of data shares (x₀, . . . , xₙ₋₁), n being an integer equal to or greater than 2, such that their arithmetic sum, modulo an integer q associated with the digital algorithm, is equal to a value of the sensitive data item;
apply a compression operation to each of the n data shares, the compression operation comprising:
application of a rounding operation to each of the n data shares, resulting in n integer rounding values (int₀, . . . , intₙ₋₁); and
application of a pseudo-fractional operation to each of the n data shares, resulting in n pseudo-fractional values (f₀, . . . , fₙ₋₁); and
generate n corrected compressed data shares (y₀, . . . , yₙ₋₁) by applying a correction operation to each of the n rounding values, based on the n pseudo-fractional values.

14. The device according to claim 13, wherein the processing device is configured to execute the instructions to apply the correction operation by carrying out:
determination of an integer c such that c is equal to value j, j∈{0, . . . n−1} when a sum of the pseudo-fractional values f₀+ . . . +fₙ₋₁ belongs to interval [jq,(j+1)q[;
generation of a correction vector (c₀, . . . , cₙ₋₁), of size n, such that an arithmetic sum modulo p of n components of the correction vector is equal to integer c; and
for each index i∈{1, n}, addition of an i-th component (cᵢ) of the correction vector to the rounding value intᵢ of an i-th share (xᵢ).

15. The device according to claim 14, wherein the processing device is configured to execute the instructions to control a deleting of the n pseudo-fractional values as a consequence of the generation of the correction vector.

16. The device according to claim 13, wherein the processing device is further configured to execute the instructions to process the n corrected compressed data shares (y₀, . . . , yₙ₋₁), in a decapsulation operation.

17. The device according to claim 13, wherein the digital algorithm is a cryptographic scheme and the processing device is a cryptographic processor or a cryptographic coprocessor.

18. The device according to claim 13, wherein the arithmetic sum, modulo an integer p associated with the digital algorithm, between the n shares (y₀, . . . , yₙ₋₁) corresponds to the sensitive data item (x), compressed, based on a second compression operation (compress_(q,p,r)), associated with the digital algorithm, the second compression operation being based on a calculation of a rounding or truncation value having a form compress_{q,p,r} where value q is an integer associated with the digital algorithm, value p is an integer corresponding to a range having a form \{0, 1, . . . , p−1} expected for a result of the second compression operation, and integer value r is a term defining the second compression operation, integer r being:
equal to 0 in response to the second compression operation associated with the digital algorithm being a truncation operation; and
equal to
$$⌊ \frac{q}{2} ⌋$$
in response to the second compression operation associated with the digital algorithm being a rounding operation.

19. The device according to claim 18, wherein:
the rounding operation, on a share xᵢ of the sensitive data item, corresponds to a calculation of integer
$${int}_{i} = ⌊ \frac{{x}_{i} p + {r}_{i}}{q} ⌋ mod p ,$$
where rᵢ is a truncation term associated with share xᵢ and └⋅┘ is the truncation operation towards an equal or immediately lower integer; and
the pseudo-fractional operation, on share xᵢ corresponds to a calculation of value fᵢ=(xᵢp+rᵢ)mod q.

20. The device according to claim 13, wherein the number n is equal to 2.
